(19) United States
(12) Patent Application Publication
(10) Pub. No.: US 2019/0208813 A1
(43) Pub. Date: Jul. 11, 2019

(54) AEROSOL-GENERATING ARTICLE, AEROSOL-GENERATING SYSTEM AND METHOD FOR MANUFACTURING AN AEROSOL-GENERATING ARTICLE

(71) Applicant: PHILIP MORRIS PRODUCTS S.A., Neuchatel (CH)

(72) Inventors: Noelia Rojo-Calderon, Neuchatel (CH); Rui Nuno Batista, Morges (CH)

(21) Appl. No.: 15/768,852

(22) PCT Filed: Oct. 21, 2016
(86) PCT No.: PCT/EP2016/075310

§ 371 Date: Apr. 17, 2018

(30) Foreign Application Priority Data
Oct. 22, 2015 (EP) 15190936.3

(51) Int. Cl. A24F 47/00; H05B 6/10

(52) U.S. Cl. CPC A24F 47/008; H05B 6/108

(57) ABSTRACT

The aerosol-generating article (14) comprises aerosol-forming substrate and a susceptor, wherein the susceptor is coated by the aerosol-forming substrate. The article further comprises a shape-giving element (20, 21), the shape-giving element (20, 21) at least partly defines an external shape and at least partly defines an external size of the aerosol-generating article (14).

The invention relates to aerosol-generating articles and an aerosol-generating system comprising such aerosol-generating articles. The invention also relates to a method for manufacturing such aerosol-generating articles.

In aerosol-generating heating systems known from the prior art a tobacco containing material of a consumable is heated by a heating element for aerosol formation. Often, a contact between the heating element and the tobacco containing material is not satisfactory. Thus, heating may be insufficient, in particular a heat transfer and distribution over an entire amount of tobacco material. This in turn may cause waste of unused tobacco material.

Therefore, it would be desirable to have an aerosol-generating article having a good heat contact between an aerosol-forming substrate and a heating element. In particular, it would be desirable to have an inductively heatable aerosol-generating article having good heat contact between a susceptor and an aerosol-forming substrate.

According to an aspect of the present invention, there is provided an aerosol-generating article. The aerosol-generating article comprises aerosol-forming substrate and a susceptor, wherein the susceptor is coated by the aerosol-forming substrate. The article further comprises a shape-giving element. The shape-giving element at least partly defines an external shape and preferably also an external size of the aerosol-generating article.

The coating of a susceptor with aerosol-forming substrate provides a very close and direct physical contact between the substrate and the susceptor. Thus, heat transfer from the susceptor to the substrate is optimized. The close contact may lead to a very homogeneous temperature profile across the aerosol-forming substrate. Thus, a total amount of substrate may be reduced due to an efficient use of the substrate. As a consequence, waste of material and cost may be reduced. Yet further, overheating of the aerosol-forming substrate may be prevented and thus combustion of the substrate and combustion products formed may be reduced or prevented. The amount of heating energy may be reduced, which may in particular be advantageous in view of longer operation time of a device or in view of battery capacity or battery size of an electronic heating device. Improved heat transfer and large contact areas may also lead to a faster heating-up of the aerosol-forming substrate and thus to shorter start-up times and less energy required for a device to get ready for use.

Depending on form or size of the susceptor, and also on composition and amount of aerosol-forming substrate coating the susceptor, a dosing regime may be chosen and varied according to a user's needs, for example, to achieve a specific consuming experience. The specific consuming experience may be varied by varying, for example, the size and shape of the susceptor to be coated, and additionally or alternatively by varying, for example an amount or composition of the aerosol-forming substrate. A dosing regime may, for example, be chosen to generate an equivalent of a predefined number of puffs, for example for one or more consuming experiences. Thus, consumption may be optimized and waste may be avoided or reduced.

This variability and flexibility of an inductively heatable aerosol-forming article allows broad range and exclusive customization of a consuming experience.

Since coatings may be applied in very consistent and reproducible manner, the aerosol-generating article comprising a coated susceptor may have very homogeneous aerosol delivery profiles and, additionally or alternatively, reproducible aerosol-delivery profiles. Thus, it is possible to improve consistency in aerosol formation between puffs during a consuming experience as well as repeatability between consuming experiences. In addition, also when heating different individual portions only of the aerosol-generating article (segmented heating), that is, when heating segments only of the coated susceptor, a homogenous or consistent aerosol generation may be provided.

Aerosol-generating devices for use with the aerosol-generating article according to the invention may be adapted to inductive heating. For example, the device may be provided with electronics and a load network including an inductor. Thus, such devices may be manufactured, requiring less power than conventionally heated devices, for example comprising heating blades, and may provide all advantages of contactless heating (for example, no broken heating blades, no residues on heating element, electronics separated from heating element and aerosol-forming substances, facilitated cleaning of the device). In particular, performance of a device used in combination with the aerosol-generating article according to the invention may be enhanced due to a ‘fresh’ heating element provided with each new aerosol-generating article. No residues may accumulate on heating elements possibly negatively influencing quality and consistency of a consuming experience.

Due to the provision of a shape-giving element in an aerosol-generating article, the aerosol-generating article may be provided with an external shape, or may at least be given a basis for a later final shape of the aerosol-generating article. With a shape-giving element, the aerosol-generating article may be provided with a shape to cope with standard heating devices, for example with a standard cylindrical or elliptical design of consumables in the form of sticks. In particular, a shape-giving element may provide the aerosol-generating article with overall proportions of prior art consumables. These overall proportions may be provided by the shape-giving element basically independent of the form of the susceptor coated with the aerosol-forming substrate. This allows to divide the process of aerosol formation from design or constructional aspects of the aerosol-generating article. Thus, aerosol-formation or aerosol delivery profiles may be optimized independently or substantially independently of an external shape of the aerosol-generating article.

The shape-giving element at least partly defines an external shape and preferably also at least partly defines an external size of the aerosol-generating article.

The shape-giving element may extend over a portion of the aerosol-generating article or may extend over an entire extension, preferably a length, of the aerosol-generating article. The shape-giving element may define the final shape of the aerosol-generating article or many define a portion of the final shape of the aerosol-generating article. The shape-giving element may define a longitudinal or lateral extension of the aerosol-generating article. Preferably, the shape-giving element defines a diameter or a length or both, a diameter and a length, of the aerosol-generating article.

By defining the external shape of the aerosol-generating article or a portion of the external shape of the aerosol-generating article, the article may have a shape and size to cope with cavities in existing aerosol-heating devices. In particular, the article may cope with tubular cavities provided for tobacco sticks comprising a tobacco plug to be heated for aerosol formation. Preferably, the shape-giving element comprises a cylindrical shape. The shape-giving element may be arranged at one end of the susceptor. The shape-giving element may be arranged to cover at least part of the susceptor or may be arranged to cover the entire susceptor or a majority of the susceptor, for example cover the susceptor along its entire length. Depending on the design of the shape-giving element, the shape-giving element covers the susceptor or the susceptor coated with aerosol-forming substrate as will be described in more detail below.

Preferably, the shape-giving element is designed such that the aerosol-generating article according to the invention corresponds to a cylindrical or rod-shaped element to be inserted into a cylindrical cavity of an aerosol-generating heating device.

With a shape-giving element, an external shape may be kept plain and simple, independent of a form or shape of the coated susceptor.

Depending on the design and arrangement of the shape-giving element in the aerosol-generating article, the shape-giving element may also facilitate a handling of the aerosol-generating article.

For example, the shape-giving element may be a base element. The susceptor may be attached, for example, mounted, to the base element in a manner such that the susceptor projects from the base element. The base element may cover a portion of the (uncoated) susceptor. Preferably, a base element defines a lateral extension, preferably a diameter, of the aerosol-generating article.

A base element may allow handing during manufacturing of the article before, during and after coating the susceptor. For example, by holding the unfinished article by the base element, any direct contact with the susceptor or an aerosol-forming substrate coating the susceptor may be avoided. By this, any damage due to physical contact with a coating may be avoided also during a final assembly of the article. Such final assembly may include, for example, an application of shape-giving element in the form of an external protection element as will be described below.

Providing a base element also allows or facilitates mass production of the aerosol-generating article. For example, conveying systems may be provided that can handle to be manufactured aerosol-generating articles batch wise or continuously. For example, a plurality of to be coated susceptors each provided with a base element may be inserted and held in trays by their base elements. The susceptors may then be lowered, for example, into a slurry of aerosol-forming substrate or be subjected to spray- or different coating methods for coating the susceptors. The susceptors may be held by the base element also after coating and during further manufacturing steps, not requiring a contacting of the aerosol-forming substrate coating.

The shape-giving element may also be an external protection element arranged over the susceptor, for example mounted over the susceptor, preferably such as to at least partially cover the susceptor coated with aerosol-forming substrate. The external protection element may partially or entirely encapsulate the susceptor.

An external protection element may define a longitudinal and lateral extension of the aerosol-forming article. Such an external protection element may in particular facilitate handling of the aerosol-generating article, preferably not allowing direct contact with the aerosol-forming substrate.

An external protection element may have any suitable size. The external protection element may have a length in a range, for example, between 8 mm and 40 mm, preferably, in a range between 8 mm and 30 mm. The external protection element may have an outer diameter in a range, for example, between 3 mm and 13 mm, preferably, in a range between 6 mm and 11 mm. The external protection element may have an inner diameter in a range, for example, between 4 mm and 12 mm, preferably, in a range between 7 mm and 10 mm.

The external protection element may be a hollow tube having two opposed open ends. One or both of the opposed ends of the protection element may be sealed by one or more frangible or removable barriers after the coated susceptor has been inserted into the hollow tube or after the hollow tube has been mounted over the susceptor or at least over the portion of the susceptor coated with aerosol-forming substrate. The open ends are preferably sealed for storing the aerosol-generating article. A sealing may, for example, be realized by providing a base element sealing one end of the hollow tube. Then only the opposed end is sealed with a frangible or removable barrier. Preferably, both opposed ends of the protection element are sealed with one or more frangible or removable barriers. This may also be favourable, for example, if a porous base element is present in the aerosol-generating article.

The one or more frangible barriers may be formed from any suitable material. For example, the one or more frangible barriers may be formed from a metal foil or film.

Preferably, the frangible barrier is formed of a material comprising no, or a limited amount of ferromagnetic material or paramagnetic material. In particular, the frangible barrier may comprise less than 20 percent, in particular less than 10 percent or less than 5 percent or less than 2 percent of ferromagnetic or paramagnetic material. By this, it may be prevented that heat is produced in the barriers in case of frangible barrier that are pierced or punctured but not removed bevor use of the aerosol-generating article.

An aerosol-generating device the aerosol-generating article is used with may comprise a piercing member configured to rupture the one or more frangible barriers sealing the aerosol-generating article. Alternatively or in addition, one or both ends of the article may be sealed by one or more removable barriers. For example, one or both of the ends may be sealed by one or more peel-off seals.

The shape-giving element may be porous or non-porous. Preferably, the shape-giving element is porous, in particular when the shape-giving element is an external protection element. Preferably, the shape-giving element is made of a porous material. A porous shape-giving element allows an air-flow to pass through the shape-giving element. A porous shape-giving element also allows an aerosol generated by heating the aerosol-forming substrate to pass through the shape-giving element, in particular to pass through an external protection element.

Materials for the shape-giving element may, for example, be cellulose based materials, such as for example but not limited to hard paper or polymeric material. The materials may in addition or alternatively be provided with micro-perforations for an air-flow to pass through the perforations in the material.

The material for the shape-giving element may be chemically resistant to the materials of the aerosol forming substrate. Additionally or alternatively, the aerosol-forming substrate may comprise an external protection layer. Such an external protection layer may prevent chemical interaction with the environment, in particular chemical reaction with a shape-giving element or may provide a moisture protection as will be described in further detail below.

The aerosol-generating article may comprise several, for example two or three shape-giving elements. In particular, the aerosol-generating article may comprise several shape-giving elements serving additional purposes or the same purpose in a different manner. For example, the aerosol-generating article may comprise a first shape-giving element being a base element and a second shape-giving element being an external protection element.

A susceptor used in the aerosol-generating article according to the invention may basically have any shape suitable for being coated with aerosol-forming substrate and suitable for providing a desired aerozolization profile. Preferably, a susceptor is pre-formed before being coated with aerosol-forming substrate.

Preferably, the susceptor is a single susceptor.

The susceptor may comprise different diameters along a length of the susceptor. Thus, when coated with aerosol-forming substrate, that portion of the aerosol-generating article relevant for aerosol formation (in the following named active portion) also comprises different diameters along a length of that portion of the article. For example, a susceptor may be a rod-shaped susceptor provided with protrusion along the rod, for example, disc-shaped protrusions arranged perpendicular to the length of the susceptor.

Different diameters may be arranged equidistantly or at varying distances along the length of the susceptor. Protrusions may have a same or different dimensions, in particular protrusions may have a same or different thickness and may have a same or different lateral extension (lateral relative to the length of the susceptor). Preferably, one protrusion has a same extension in any lateral direction around a longitudinal axis of the susceptor.

The susceptor may, for example, be a susceptor coil. After coating the susceptor coil with aerosol-forming substrate, the portion of the aerosol-generating article relevant for aerosol formation, that is the active portion, also has the form of a coil.

The active portion may correspond to the entire susceptor surface. However, the active portion may correspond to a part of the surface of the susceptor. Preferably, the active portion corresponds to a major part of the susceptor surface or the entire susceptor surface. A major part of the surface corresponds to at least 55 percent of the susceptor surface, preferably, at least 70 percent, more preferably at least 80 percent of the susceptor surface.

For example, a part of the susceptor may be inserted into a base element. Preferably, that part of the susceptor is not coated with aerosol-forming substrate.

Preferably, the susceptor has a cylindrical shape.

The term ‘cylindrical’ is herein used to include also ‘substantially cylindrical’. ‘Cylindrical’ is to be understood to include forms which have the shape of a cylinder or a tapered cylinder of circular or substantially circular cross-section, or which have the shape of a cylinder or a tapered cylinder of elliptical or substantially elliptical cross-section. ‘Cylindrical’ is herein also understood to include susceptor shapes, wherein the envelope of the susceptor shape has a cylindrical or substantially cylindrical shape. For example, the susceptor may have a longitudinal rotational axis and varying cross-sections along the longitudinal axis. While various combinations and arrangements of these different shapes of susceptor are possible, in preferred embodiments the susceptor has a shape, wherein the envelope of the susceptor shape has the shape of a cylinder having a circular cross-section. In preferred embodiments of the shape-giving element, the shape-giving element has the shape of a cylinder having a circular cross-section.

An aerosol-generating article may comprise different aerosol-forming substrate along a length of the susceptor. That is, the susceptor may be coated with different aerosol-forming substrate along the length of the susceptor.

A different aerosol-forming substrate may differ in any one or a combination of for example: number of aerosol-forming substrate coatings, for example one or two coatings; thickness of the substrate; porosity or composition of the aerosol-forming substrate or porosity or composition of more than one aerosol-forming substrate coating; or may differ in aerosol delivery profiles. By having different aerosol-forming substrate along a length of the susceptor, aerosol formation and aerosol composition may be selected and controlled according to a desired consuming experience. If segmented heating is available in an aerosol-generating device, individual susceptor segments of the aerosol-generating article according to the invention may be heated, for example, serially such as to achieve a certain consuming experience, or additionally or alternatively, to achieve consistent aerosol formation according to one, two or more puffs.

Different coating specifics may be achieved by providing coating materials having different material compositions or different amounts of the same or different material. Different coating specifics may also be achieved by different coating techniques. Different coating techniques are preferably chosen for achieving different coating surfaces or substrate densities of a coating.

Aerosol-forming substrate may be a tobacco containing aerosol-forming substrate. The aerosol-forming substrate may be provided in the form of a slurry. Depending on a coating method for applying a substrate onto a susceptor a moisture content of the slurry may vary.

The tobacco containing slurry and the aerosol-forming substrate made from the tobacco containing slurry comprises tobacco particles, fiber particles, aerosol former, binder and for example also flavours. Preferably, a coating is a form of reconstituted tobacco that is formed from the tobacco containing slurry.

Tobacco particles may be of the form of a tobacco dust having particles in the order of 30 micrometers to 250 micrometers, preferably in the order of 30 micrometers to 80 micrometers or 100 micrometers to 250 micrometers, depending on the desired coating thickness.

Fiber particles may include tobacco stem materials, stalks or other tobacco plant material, and other cellulose-based fibers such as wood fibers having a low lignin content. Fiber particles may be selected based on the desire to produce a sufficient tensile strength for the coating versus a low inclusion rate, for example, an inclusion rate between approximately 2 percent to 15 percent. Alternatively, fibers, such as vegetable fibers, may be used either with the above fiber particles or in the alternative, including hemp and bamboo.

Aerosol formers included in the slurry for forming the coating may be chosen based on one or more characteristics. Functionally, the aerosol former provides a mechanism that allows it to be volatilized and convey nicotine or flavouring or both in an aerosol when heated above the specific volatilization temperature of the aerosol former. Different aerosol formers typically vaporize at different temperatures. An aerosol former may be chosen based on its ability, for example, to remain stable at or around room temperature but able to volatize at a higher temperature, for example, between 40 degree Celsius and 450 degree Celsius. The aerosol former may also have humectant type properties that help maintain a desirable level of moisture in an aerosol-forming substrate when the substrate is composed of a tobacco-based product including tobacco particles. In particular, some aerosol formers are hygroscopic material that function as a humectant, that is, a material that helps keep a substrate containing the humectant moist.

One or more aerosol former may be combined to take advantage of one or more properties of the combined aerosol formers. For example, triacetin may be combined with glycerin and water to take advantage of the triacetin's ability to convey active components and the humectant properties of the glycerin.

Aerosol formers may be selected from the polyols, glycol ethers, polyol ester, esters, and fatty acids and may comprise one or more of the following compounds: glycerin, erythritol, 1,3-butylene glycol, tetraethylene glycol, triethylene glycol, triethyl citrate, propylene carbonate, ethyl laurate, triacetin, meso-Erythritol, a diacetin mixture, a diethyl suberate, triethyl citrate, benzyl benzoate, benzyl phenyl acetate, ethyl vanillate, tributyrin, lauryl acetate, lauric acid, myristic acid, and propylene glycol.

A typical process to produce a slurry for a tobacco containing aerosol-forming substrate includes the step of preparing the tobacco. For this, tobacco is shredded. The shredded tobacco is then blended with other kinds of tobacco and grinded. Typically, other kinds of tobacco are other types of tobacco such as Virginia or Burley, or may for example also be differently treated tobacco. The blending and grinding steps may be switched. The fibers are prepared separately and preferably such as to be used for the slurry in the form of a solution. Since fibers are mainly present in the slurry for providing stability to a coating, the amount of fibers may be reduced or fibers may even be omitted due to the aerosol-forming substrate coating being stabilized by the susceptor.

If present, the fiber solution and the prepared tobacco are then mixed. The slurry is then transferred to a coating device. After single or multiple-coating with the same or different slurries, the aerosol-forming substrate is then dried, preferably by heat and cooled after drying.

Preferably, the tobacco containing slurry comprises homogenized tobacco material and comprises glycerin as aerosol former. Preferably, the coating of aerosol-forming substrate is made of a tobacco containing slurry as described above.

Advantageously, aerosol-forming substrate coating the susceptor is porous to allow volatilized substances to leave the substrate. Due to the aerosol-forming substrate forming a coating of the susceptor material, only a small amount of substrate must be heated by the susceptor compared to aerosol-forming substrates heated by, for example, a heating blade. Thus, also coatings having no or only little porosity may be used. A coating with small thickness may, for example, be chosen to have less porosity than a coating with large thickness.

A thickness of an aerosol-forming substrate is between 0.1 mm and 4 mm, preferably, between 0.2 mm and 2 mm.

A coating of the susceptor may be a single coating or a multiple coating.

Multiple-coatings may be identical, for example in composition and density. Preferably, individual coatings of multiple-coatings differ in at least one of composition, porosity, coating thickness or shape of coating surface.

By choosing more than one but differing aerosol-forming substrates, aerosolization may be varied and controlled for a given inductive heating device. Also the delivery of different substances, such as, for example, nicotine or flavours may be varied and controlled for a given inductive heating device. In particular, an aerosol-generating system with customized performance may be provided.

The aerosol-forming substrate may further comprise at least one protection layer. A protection layer may, for example, assure or enhance a shelf life of the aerosol-generating article. Additionally or alternatively a protection layer may optimize use and vaporization behaviour of the aerosol-generating article.

A protection layer may be an outer protection layer protecting the aerosol-forming substrate against environmental influences. Preferably, an outer protection layer is a moisture protection layer. Preferably, an outer protection layer is an outermost material of the aerosol-forming substrate coating.

A protection layer may also be an inner protection layer, for example, arranged between two coatings. An inner protection layer may be favourable if a contact between two coatings shall be allowed only upon consumption of the product.

A protection layer may also be used for marking purposes, for example, by adding a colour to an outer protection layer.

Susceptors may basically be coated with one or several coatings by any kind of wet coating or dry coating. Wet or dry coating may be, for example, powder or slurry coating, including, for example, electrostatic powder coating and spray coating. Preferably, dip coating or continuous dip coating is used for coating a susceptor with aerosol-forming substrate. In dip coating, a susceptor is dipped once or several times into one or several aerosol-forming slurries. In continuous dip coating, a continuous profile of susceptor material may, for example, be unwound from a bobbin and be continuously guided through one or several baths containing aerosol-forming substrate slurry. The continuous profile of coated susceptor material may then be cut into portions of a length to be used in the aerosol-generating article.

Preferably, the susceptor used in the aerosol-generating article according to the invention is coated with one or two coatings according to any one of the above coating methods.

These coating methods are standard reliable industrial processes that allow for mass production of coated objects. These coating processes also enable high product consistency in production and repeatability in performance of the aerosol-generating articles.

In general, a susceptor is a material that is capable of absorbing electromagnetic energy and converting it to heat. When located in an alternating electromagnetic field, typically eddy currents are induced and hysteresis losses occur in the susceptor causing heating of the susceptor. Changing electromagnetic fields generated by one or several inductors, for example, induction coils of an inductive heating device heat the susceptor. The heated susceptor then transfers the heat to the surrounding coating of aerosol-forming substrate, mainly by conduction of heat such that an aerosol is formed. Such a transfer of heat is best, if the susceptor is in close thermal contact, preferably close physical contact, with tobacco material and aerosol former of the aerosol-forming substrate coating. Due to a coating process, a close interface between susceptor and aerosol-forming substrate coating is formed.

The susceptor may be formed from any material that can be inductively heated to a temperature sufficient to generate an aerosol from the aerosol-forming substrate. Preferred susceptors comprise a metal or carbon. A preferred susceptor may comprise or consist of a ferromagnetic material, for example ferritic iron, a ferromagnetic alloy, such as a ferromagnetic steel or stainless steel, ferromagnetic particles, and ferrite. A suitable susceptor may be, or comprise, aluminium. Preferred susceptors may be heated to a temperature in excess of 250 degrees Celsius. Preferred susceptors are metal susceptors, for example stainless steel. However, susceptor materials may also comprise or be made of graphite, molybdenum, silicon carbide, aluminum, niobium, Inconel alloys (austenite nickel-chromium-based superalloys), metallized films, ceramics such as for example zirconia, transition metals such as for example Fe, Co, Ni, or metalloids components such as for example B, C, Si, P, Al.

The susceptor may also be a multi-material susceptor and may comprise a first susceptor material and a second susceptor material. The first susceptor material may be disposed in intimate physical contact with the second susceptor material. The second susceptor material preferably has a Curie temperature that is below the ignition point of the aerosol-forming substrate. The first susceptor material is preferably used primarily to heat the susceptor when the susceptor is placed in a fluctuating electromagnetic field. Any suitable material may be used. For example the first susceptor material may be aluminium, or may be a ferrous material such as a stainless steel. The second susceptor material is preferably used primarily to indicate when the susceptor has reached a specific temperature, that temperature being the Curie temperature of the second susceptor material. The Curie temperature of the second susceptor material can be used to regulate the temperature of the entire susceptor during operation. Suitable materials for the second susceptor material may include nickel and certain nickel alloys.

By providing a susceptor having at least a first and a second susceptor material, the heating of the aerosol-forming substrate and the temperature control of the heating may be separated. Preferably the second susceptor material is a magnetic material having a second Curie temperature that is substantially the same as a desired maximum heating temperature. That is, it is preferable that the second Curie temperature is approximately the same as the temperature that the susceptor should be heated to in order to generate an aerosol from the aerosol-forming substrate.

A longitudinal extension or length of a susceptor may, for example be between 5 mm and 30 mm, preferably between 5 mm and 15 mm. Therein, only a portion of the susceptor may be coated with aerosol-forming substrate as described above.

A lateral extension of a susceptor may, for example, be between 0.5 mm and 11 mm, preferably between 1 mm and 6 mm.

The aerosol-generating article may further comprise a filter element. The filter may be a filter as known from stick-shaped consumables for aerosol-generating heating devices. The filter may, for example, comprise or be made of polylactic acid (PLA), for example comprise crimped PLA sheet. Advantageously, a filter element is arranged next to the aerosol-forming substrate. Preferably, the filter element is arranged in an end-to-end relationship with an external protection element surrounding the aerosol-forming substrate. Preferably, external protection element and filter element are rod-shaped, preferably having a same or substantially same outer diameter. By this a rod-shaped aerosol-generating article comprising an inductively heatable aerosol-forming substrate and a filter element may be formed that may be used as a stick in an aerosol-generating device.

According to another aspect of the invention, there is provided an aerosol-generating system. The aerosol-generating system comprises an aerosol-generating article according to the invention and as described herein. The system further comprises a power source connected to a load network. The load network comprises an inductor for being inductively coupled to the susceptor of the aerosol-generating article.

The inductor may, for example, be embodied as one or more induction coils. If one induction coil only is provided, the single induction coil is inductively coupled to the entire susceptor or to the portion of the susceptor coated with aerosol-forming substrate, respectively. If several induction coils are provided, each induction coil may heat a section of the susceptor.

The system may further comprise an aerosol-generating device comprising a device housing comprising a device cavity arranged in the device housing. The device cavity then contains the aerosol-generating article, while the inductor is provided in the device such that the inductor is inductively coupled to the susceptor of the aerosol-generating article when the article is positioned in the cavity.

The aerosol-generating device may comprise a piercing member. Depending on the embodiment of the aerosol-generating article, the piercing member may be provided for piercing one or more frangible barriers or, for example, also a shape-giving element to provide an air-flow to pass along the aerosol forming substrate.

Advantages and further aspects of the system according to the invention have been described relating to the aerosol-generating article according to the invention and will not be repeated.

According to an aspect of the invention there is provided a method for manufacturing an aerosol-generating article. The method comprises the steps of coating a susceptor with aerosol-forming substrate, arranging an external protection element over the susceptor coated with aerosol-forming substrate and sealing one or both open ends of the external protection element by one or more frangible or removable barriers. Thereby the protection element may at least partly define an external shape and at least partly define an external size of an aerosol-generating article comprising the coated susceptor and the protection element.

The method may comprise the further steps of mounting the susceptor to a base element such that the susceptor projects from the base element and coating the susceptor with aerosol-forming substrate by holding the base element and immersing the susceptor into a slurry of aerosol-forming substrate.

Advantages and further aspects of the method according to the invention have also been described relating to the aerosol-generating article according to the invention and will not be repeated.

The invention is further described with regard to embodiments, which are illustrated by means of the following drawings, wherein:

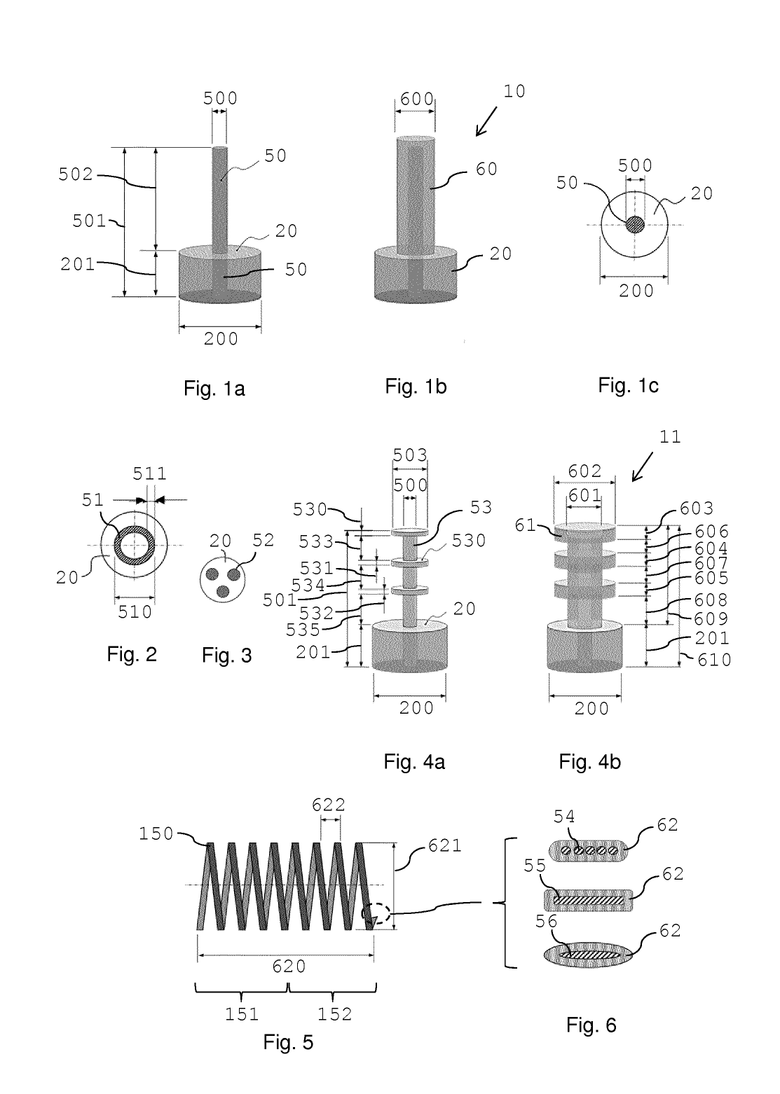

FIG. 1a-c show a first embodiment of an aerosol-generating article with base element;

FIG. 2, 3 show top views of variants of susceptor cores of aerosol-generating articles with base element;

FIG. 4a,4b illustrate a second embodiment of an aerosol-generating article with base element;

FIG. 5 shows yet a further embodiment of an aerosol-generating article without shape-giving element;

FIG. 6 shows different cross sections of the aerosol-generating article of FIG. 5;

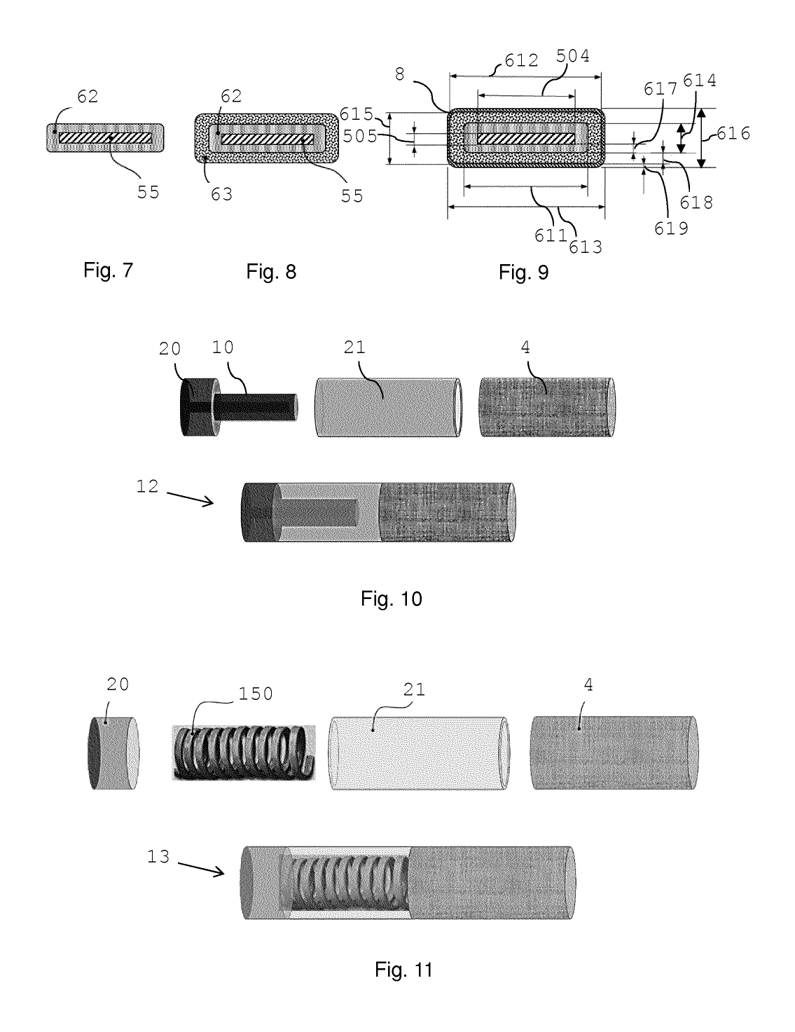

FIGS. 7 to 9 illustrate different coatings of the aerosol-generating article of FIG. 5;

FIG. 10 is an exploded and assembled view of a first embodiment of an aerosol-generating article with base element and external protection element;

FIG. 11 is an exploded and assembled view of a second embodiment of an aerosol-generating article with base element and external protection element;

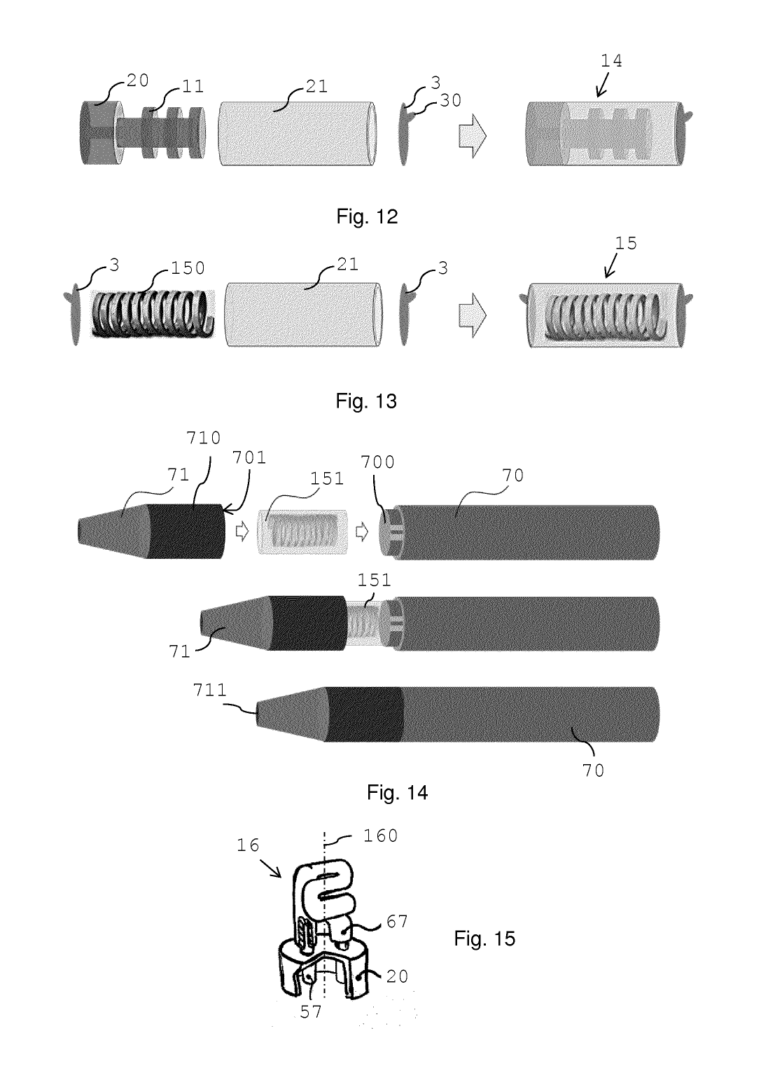

FIG. 12 is an exploded and assembled view of a third embodiment of an aerosol-generating article with base element and external protection element;

FIG. 13 is an exploded and assembled view of an embodiment of an aerosol-generating article with external protection element;

FIG. 14 shows different assembling stages of an inductive heating device;

FIG. 15 shows a further embodiment of an aerosol-generating article with base element.

FIG. 1a shows a cylindrical pin-shaped susceptor 50, which is inserted into the center of a base element 20 and extends therefrom. The base element 20 also has a cylindrical shape and defines an outer lateral shape of the final aerosol-generating article 10 as being cylindrical with a diameter corresponding to the diameter 200 of the base element 20.

The base element 20 may also serve as handling element during manufacturing of the article, that is, while coating the susceptor 50 with aerosol-forming substrate 60 to form the final article 10. The susceptor portion inserted in the base element 20 is not coated with aerosol-forming substrate, as may be seen in FIG. 1b. In FIG. 1c the uncoated article of FIG. 1a is shown from above.

Exemplary sizes for the aerosol-generating article of FIGS. 1a-c are:

Diameter 500 of the susceptor pin 50: 0.5 mm to 3.5 mm, preferably 1 mm to 1.5 mm; Length 501 of susceptor pin 50: 7 mm to 27 mm, preferably 7 mm to 15 mm; wherein the length of the susceptor pin coated with aerosol-forming substrate (length of the active portion) 502 is 8 mm to 20 mm, preferably 8 mm to 15 mm.

Diameter 200 of the base element 20: 4 mm to 12 mm, preferably 7 mm to 10 mm; Height 201 of the base element: 5 mm to 12 mm, preferably 5 mm to 9 mm.

Diameter 600 of the coated susceptor pin: 3 mm to 7 mm, preferably 3 mm to 5 mm.

FIG. 2 and FIG. 3 show further top views of embodiments of susceptor shapes arranged on or inserted into a tubular base element 20. FIG. 2 is a susceptor in the shape of a hollow tube 51 coaxially arranged with the base element. An outer diameter 510 of the hollow susceptor tube 51 may be 3 mm to 8 mm, preferably 5 mm to 7 mm; wherein a wall thickness 511 of the hollow tube 51 may be between 0.075 mm and 1 mm, preferably between 0.075 mm and 0.7 mm.

In FIG. 3, three pin-shaped susceptors 52, for example as the one shown in FIG. 1a are attached to the base element 20. The three pin-shaped susceptors 52 are symmetrically and regularly arranged around the center of the base element 20. The longitudinal axis of the pin-shaped susceptors 52 are arranged parallel to a central longitudinal axis of the base element 20.

In FIG. 4a and FIG. 4b an aerosol-generating article 11 is shown having several cross sections along the longitudinal axis of the susceptor 53. The susceptor 53 is basically pin-shaped, for example, with same length and diameter dimensions as the pin-shaped susceptor 50 shown and described in FIG. 1a. However, the susceptor 53 has three disc-shaped elements 530 arranged distanced from each other along the length of the susceptor. The discs 530 as well as the pin is covered by aerosol-forming substrate 61 and forms an antenna-like active portion of the aerosol-forming article 11. The active portion of the article is understood as the portion of the article involved in aerosol generation, that is, susceptor covered with aerosol-forming substrate.

The discs 530 may be distanced equidistantly from each other and from the base element 20 or at different distances. For example, the discs 530 may be arranged with reduced distances 533,534,535 versus an end of the article 11 opposite the base element 20.

The distances 533,534,535 of the susceptor discs 530 may be in a range between 1.5 mm and 4 mm, preferably between 1.5 mm and 3 mm.

The diameter 503 of the susceptor discs 530 may be in a range between 3 mm and 7 mm, preferably between 3 mm and 5 mm.

The thickness 530,531,532 of the susceptor discs 530 may be equal or different from each other. The thickness of the susceptor discs 530 may be in a range between 0.5 mm and 3.5 mm, preferably between 1 mm and 1.5 mm.

When covered with aerosol-forming substrate a thickness of the discs 603,604,605 may be in a range between 1.5 mm and 6 mm, preferably between 1.5 mm and 3 mm. The distances 606,607,608 between the individual discs or between a lowest disc and the base element 20 are reduced according to a coating thickness of the aerosol-forming substrate coating. The reduces distances 606,607,608 lie in a range between 1 mm and 3 mm, preferably between 1 mm and 2 mm.

The diameter 601 of the pin-shaped portion of the susceptor when coated with substrate is in a range between 3 mm to 7 mm, preferably between 3 mm to 5 mm. The diameter 602 of the coated discs is in a range between 3.5 mm and 8.5 mm, preferably in a range between 4 mm and 6 mm.

The height 609 of the active portion of the article 11 or the total height 610 of the article 11 corresponds to the height 105 of the uncoated article as shown in FIG. 4a plus a coating thickness of the aerosol-forming substrate coating 61.

FIG. 5 shows a susceptor coil 150 coated with aerosol-forming substrate. Such a coil 150 is particularly suited for forming a cylindrical aerosol-generating article.

A length 620 of the coil 150 may be between 5 mm and 30 mm, preferably between 5 mm and 15 mm. A diameter 621 of the coil may be between 3 mm and 11 mm, preferably between 5 mm and 6 mm. A distance 622 between neighbouring coil windings may be between 1 mm and 7 mm, preferably between 1 mm and 3 mm.

The susceptor coil 150 may be provided with different aerosol-forming substrate coatings along the length of the susceptor coil 150. For example, the coil 150 may be (virtually) divided into two segments 151,152. Different coatings may be provided in the two segments 151,152 of the coil. For example, the first segment 151 and the second segment 152 may vary in thickness of the coating, porosity of the coating, may have different number of coatings, or a combination thereof.

FIG. 6 shows examples of enlarged cross sections of a metal susceptor core coated with aerosol-forming substrate, which may, for example represent the coil material forming the article of FIG. 5. In the top most drawing, the metal susceptor core is formed by several wires 54, for example a Litz wire. In the intermediate drawing the metal susceptor core is a metal band 55 of rectangular cross-sectional shape. In the bottom drawing, the metal susceptor core is a lens shaped metal band 56. In this example, each of the susceptors are coated with one layer of aerosol-forming substrate 62.

In FIG. 7 the rectangular shaped susceptor core 55, for example a ferromagnetic metal band, is covered with a first coating 62 of aerosol-forming substrate. The first coating 62 of aerosol-forming substrate may, for example be a tobacco containing substrate. The first coating 62 may, for example be designed to provide a flavour splash. A flavour splash may, for example, provide freshness or a soothing action, for example with a menthol or chocolate flavour.

In FIG. 8 the product is provided with a second aerosol-forming substrate coating 63. This second coating 63 preferably has a lower density than the first coating 62 and may have a different composition than the first aerosol-forming substrate 62. In FIG. 9 the product is provided with an external protection layer 8. Preferably, the protection layer 8 provides moisture protection to secure or prolong a shell life of the product.

Exemplary dimensions of the products shown in FIG. 7 to FIG. 9 may be:

Metal band width 504: 1.5 mm to 5 mm, preferably 1.8 mm to 3 mm; metal band thickness 505: 0.25 mm to 2 mm, preferably 0.45 mm to 1.2 mm.

Thickness 617 of the first coating 62: 0.1 mm to 1.5 mm, preferably 0.25 mm to 1 mm;

Thickness 618 of the second coating 63: 0.1 mm to 1.5 mm, preferably 0.25 mm to 1.1 mm;

Thickness 619 of the protection layer: 0.2 mm to 0.8 mm, preferably 0.25 mm to 0.5 mm.

The product shown in FIG. 7 has a height 614 in a range between 0.5 mm and 3 mm, preferably between 0.7 mm and 2.1 mm; and a width 611 in a range between 1.8 mm and 4 mm, preferably 2.1 mm and 3.8 mm.

The product shown in FIG. 8 has a height 615 in a range between 0.75 mm and 4 mm, preferably between 0.75 mm and 3.2 mm; and a width 612 between 2.15 mm and 5 mm, preferably between 2.2 mm and 4.3 mm.

The product shown in FIG. 9 has a height 616 in a range between 0.78 mm and 5 mm, preferably between 0.81 mm and 4.2 mm; and a width 613 in a range between 2.45 mm and 6 mm, preferably between 2.31 mm and 5 mm;

FIG. 10 shows an exploded and assembled view of the article 10 of FIG. 1b, which is further provided with an external protection element 21 and a filter element 4.

The tubular shaped external protection element 21 is arranged over the pin shaped coated susceptor as well as over the base element 20. This may, for example, be done by pushing the pre-formed protection element 21 over the article 10 or by wrapping the article 10 with a sheet of protection material forming a rod-shaped protection element. Protection element 21 and base element 20 are attached to each other, for example by an adhesive or through a form fit.

Preferably, the protection element 21 is made of a cellulose based porous material.

The rod-shaped filter element 4, for example a polylactic acid filter, is aligned in an end-to-end position with the protection element 21 and may be affixed to the protection element 21, for example by a wrapping material (not shown). The so formed aerosol-generating article 12 has the rod-shaped form and set-up of a conventional cigarette, however, adapted to be used in an inductive heating device.

FIG. 11 shows an exploded and assembled view of another aerosol-generating article using a coated coil 150 as shown in FIG. 5 as active portion of the article. A base element 20, the coil 150, a tubular shaped external protection element 21 and a filter element 4 are aligned along a longitudinal axis of all elements.

The tubular shaped external protection element 21 is arranged over the coil 150 and the base element 20. The so combined element is aligned in an end-to-end position with the rod-shaped filter element 4. Base element 20 on one side and filter element 4 on the opposite side retain the coil 150, otherwise not fixed to another element, within the protection element 21.

The so formed aerosol-generating article 13 has the rod-shaped form and set-up of a conventional cigarette, however, adapted be used in an inductive heating device.

FIG. 12 illustrates an exploded and assembled view of yet another embodiment of an aerosol-generating article 14 to be used in an inductive heating device. The article 11 shown in FIG. 4b is provided with a tubular shaped external protection element 21. The protection element is arranged over the entire length of the article 11 including base element 20. In this embodiment, preferably, the base element 20 is of a dense material providing a protection for the coated susceptor (the active portion of the article) to the environment. Thus, the one open end of the tubular protection element 21 arranged over the base element 20 is closed or possibly sealed by the base element 20. The other open end of the protection element opposite the base element is sealed with a peelable seal 3 provided with a flap 30 for removing the seal 3 before use of the article.

The peelable seal 3 may also be designed as pierceable seal, which does not have to be removed before use. A piercable seal is preferably pierced by appropriate piercing means of a heating device.

FIG. 13 illustrates an exploded and assembled view of an embodiment of an aerosol-generating article 15 without base element. A coil 150 as shown and described in FIG. 5 is inserted into a tubular shaped external protection element 21. The length of the protection element 21 is longer than the coil 150 such that the coil 150 may be entirely inserted into the protection element 21. Both open ends of the protection element 21 are sealed with a peelable seal 3 each provided with a flap 30 for removing the seals before use of the article 15. After removal of the seals 3, an airflow may pass basically unhindered through and along the coil 150 and inside of the protection element 21.

FIG. 14 shows a schematic illustration of an inductively heatable aerosol-generating device for receiving a tubular shaped aerosol-generating article as shown and described in various embodiments herein.

The device comprises a main housing 70 and a mouthpiece 71.

The main housing 70 mainly comprises a battery and a power management system (not shown).

The mouthpiece 71 forms the proximal or most downstream element of the device. The mouthpiece 71 comprises a tubular section 710 surrounding a cavity 701 arranged within the tubular section 710 of the mouthpiece. The cavity 701 is provided for receiving the aerosol-generating article. In the example shown in FIG. 14, the seals 3 of the aerosol-forming article 15 of FIG. 13 (or FIG. 12 likewise) have been removed. The ready to be used article 151 is inserted into the cavity 701 of the mouthpiece 71.

In use of the device, the mouthpiece 71 is removable from the housing 70, such as to provide open access to the cavity 701. Preferably, removal is a complete detachment of the mouthpiece 71 from the housing 70 as shown in the example of FIG. 14. However, removal may also be a hinging away of the mouthpiece, where the mouthpiece remains connected to the housing 70 via a hinge.

After inserting the aerosol-forming article 151 into the device, the previously removed mouthpiece 71 may be repositioned on the housing 70.

The mouthpiece 71 comprises an inductor (not shown), for example in the form of an induction coil, for inductively heating the susceptor contained in the aerosol-forming article 151 arranged in the cavity 701. The induction coil is preferably arranged to surround the cavity 701 in longitudinal direction such as to be able to inductively heat susceptor material arranged in the cavity 701.

A top of the cavity 701 as well as the proximal end 700 of the housing 70 may be closed by a porous element, for example a disc of porous material or a grid or mesh. The porous elements (in the mounted state of the mouthpiece) are adapted to hold the article 151 in place in the cavity 701 but allow an airflow to pass through the porous elements, through the cavity 701 and through the mouthpiece 71.

The main housing 70 may be provided with air-inlet channels to allow air from the environment to enter the housing 70 and pass into and through the aerosol-generating article or into and through the cavity 701, respectively. The air inside the cavity may pick up aerosol formed in the cavity by heating the aerosol-generating article 151. The aerosol containing air continuous further downstream leaving the device through an outlet opening 711 of the mouthpiece 71 at the proximal end of the mouthpiece 71.

FIG. 15 shows an embodiment of an aerosol-generating article 16 having an irregular shape. The two ends of an elongate susceptor 57 are inserted into a tubular base element 20. The active portion of the susceptor, coated with aerosol-forming substrate 67, comprises several windings. The shape of the active portion of the article 16 extends along a longitudinal axis 160 of the article 16, would fit into and could if desired be provided with a tubular external protection element as described above.

1. An aerosol-generating article comprising aerosol-forming substrate and a susceptor, the susceptor being coated by the aerosol-forming substrate, the article further comprising a shape-giving element, the shape-giving element at least partly defining an external shape and at least partly defining an external size of the aerosol-generating article, wherein the shape-giving element comprises a cylindrical shape and defines a diameter of the aerosol-generating article.

2. (canceled)

3. The article of claim 1, wherein the shape-giving element is a base element, and wherein the susceptor is attached to the base element in manner such as to project from the base element.

4. The article of claim 1, wherein the shape-giving element is an external protection element arranged over the susceptor.

5. The article of claim 4, wherein the external protection element is a hollow tube having two opposed open ends, wherein one or both of the opposed ends of the protection element is sealed by one or more frangible or removable barriers.

6. The article of claim 1, wherein the shape-giving element is porous.

7. The article of claim 1, comprising a first shape-giving element being a base element and a second shape-giving element being an external protection element.

8. The article of claim 1, wherein the susceptor is a single susceptor having a cylindrical shape.

9. The article of claim 1, wherein the susceptor comprises different diameters along a length of the susceptor.

10. The article of claim 1, wherein the susceptor is a susceptor coil.

11. The article of claim 1, comprising different aerosol-forming substrate along a length of the susceptor.

12. The article of claim 4, further comprising a filter element arranged in an end-to-end relationship with the external protection element.

13. An aerosol-generating system comprising:
the aerosol-generating article of claim 1; and
a power source connected to a load network, the load network comprising an inductor for being inductively coupled to the susceptor of the aerosol-generating article.

14. A method for manufacturing an aerosol-generating article, the method comprising the steps of:
coating a susceptor with aerosol-forming substrate;
arranging an external protection element over the susceptor coated with aerosol-forming substrate, the protection element at least partly defining an external shape and at least partly defining an external size of an aerosol-generating article comprising the coated susceptor and the protection element; wherein the protection element comprises a cylindrical shape and defines a diameter of the aerosol-generating article;
sealing one or both open ends of the external protection element by one or more frangible or removable barriers.

15. The method of claim 14, further comprising the steps of:
mounting the susceptor to a base element such that the susceptor projects from the base element;
coating the susceptor with aerosol-forming substrate by holding the base element and immersing the susceptor into a slurry of aerosol-forming substrate.
